(19) United States
(12) Patent Application Publication
(10) Pub. No.: US 2024/0388374 A1
(43) Pub. Date: Nov. 21, 2024

(54) PACKETIZATION WITHIN MULTI-STREAM WIRELINE-WIRELESS PHYSICALLY CONVERGED ARCHITECTURES

(71) Applicant: PHYTunes, Inc., Palo Alto, CA (US)

(72) Inventors: Akula Aneesh REDDY, San Jose, CA (US); Jisung OH, Palo Alto, CA (US); Vinay JOSEPH, KERALA (IN)

(73) Assignee: PHYTunes, Inc., Palo Alto, CA (US)

(21) Appl. No.: 18/197,990

(22) Filed: May 16, 2023

(51) Int. Cl. H04J 3/08

(52) U.S. Cl. CPC H04J 3/08

(57) ABSTRACT

Embodiments of the present invention provide systems, devices and methods for multiplexing a plurality of streams into a multi-stream signal and demultiplexing a multi-stream signal into a plurality of streams within a wireline-wireless architecture. In certain examples, multi-stream signals are generated for transmission onto a wireline segment coupled to a wireless segment. In other examples, multi-stream signals are generated from wireless signals and transmitted onto a wireline segment.

### BACKGROUND

### A. Technical Field

The present invention relates generally to telecommunication systems, and more particularly, to wireline-wireless physically converged communication architectures that may deploy a variety of different multiplexing and demultiplexing techniques for multi-stream signals across one or more segments within the architectures.

### B. Background of the Invention

One skilled in the art understands the importance of wireless communication systems (including LTE, 5G, and Wi-Fi architectures) and the complexity of these systems as they are constructed and maintained around the world. As the complexity of these systems increases and the resources available to them are allocated across an increasingly higher frequency spectrum, the management of wireless channels becomes more challenging. For example, a cellular base station or Wi-Fi access point must manage many channels in communicating with a remote device (such as a User Equipment [“UE”] within a cell or a remote device within a Wi-Fi Local Area Network [“LAN”]) while the characteristics of these channels are constantly changing. This management of channels becomes more challenging in dense cities in which wireless signals must traverse a variety of physical barriers and address complex interference patterns to reach a UE such as a cellphone. This channel quality and range issue is particularly problematic when channel frequencies increase and are more sensitive to interference, noise, varying channel properties and obstacle density.

Cellular subscriber lines (hereinafter, “CSL”) employ the novel concept of using the existing wireline infrastructure (e.g., telephone lines, fiber-optic cables, Ethernet wires, coaxial cables) in conjunction with a wireless infrastructure to extend the coverage of cellular or Wi-Fi signals quickly, inexpensively, and securely within a building.

The architecture of the cloud-based CSL networks implements a unit at each of the two ends of the wireline connection: the CSL-intermediate-frequency (“CSL-IF”) unit IF-modulates a wireless or wireline downlink baseband signal and transmits the modulated signal to a CSL-radio-frequency (“CSL-RF”) unit at the other end of the wireline. The CSL-RF unit up-converts the signal for downlink wireless transmission to nearby client devices, such as IoT devices and smartphones. In certain examples, the CSL-IF unit is interfaced with a baseband unit located at a cell-tower or at a central office of the CSP. In other examples, the CSL-IF unit is interfaced with a Wi-Fi signal source that may be located in a variety of different wireless/wireline equipment. For downlink, the CSL-IF unit generates baseband digital streams from the BBU output/Wi-Fi equipment. For uplink, the CSL-RF unit receives wireless signals from nearby client devices, intermediate-frequency modulates the signals, and transmits the modulated signal to the CSL-IF unit at the other end of the wireline. The CSL-IF unit converts the baseband digital streams to specific O-RAN split signals for the BBU input/Wi-Fi equipment.

The wireline medium connecting the CSL-IF and CSL-RF units impacts CSL's performance. The wire is used as a transmission medium for IF-modulated downlink baseband signals to the CSL-RF unit. The CSL-RF unit may implement beamforming techniques to focus a downlink wireless signal toward a recipient UE. This beamforming results in interference reduction within the cell/Wi-Fi LAN (i.e., the CSL-RF unit service area) and improves power characteristics by focusing transmission power to the UE/remote device. The wire is used as a transmission medium for IF-modulated uplink baseband signals to the CSL-IF unit. One skilled in the art will recognize that the transmission characteristics of the wireline segments and the wireless segments of the CSL architecture may meaningfully vary.

Within this CSL architecture, managing bandwidth usage and effectively constructing signals across the various segments is a challenge. Interference and signal degradation occur within wireline and wireless transmission as a signal propagates through a wireline-wireless connection and may affect a variety of performance parameters including segment bandwidth. Accordingly, the performance of one segment may adversely affect the performance of other segments within this architecture and may reduce the performance of the overall system.

Accordingly, what is needed are systems, devices and methods that address the above-described issues.

### SUMMARY OF THE INVENTION

Embodiments disclosed herein are systems, devices, and methods that can be used to provide improved performance (e.g., bandwidth, data rate, quality of service, coverage, etc.) on wireline-wireless connectivity by packetizing data within a wireline segment to achieve a preferred performance of the wireline-wireless architecture. In certain embodiments, multiplexing of streams occurs for transmission of multiple streams within a wireline segment that results in preferred transmission characteristics on the wireline segment and enables subsequent generation of a wireless signal at a distribution node (e.g., a CSL-RF unit). For example, wireline packets may be constructed that provide one or more of control signals, preamble and postamble elements in addition to data signals so that multiple data signals from multiple streams may be combined into a multiplexed signal such that the wireline signal is effectively communicated across the wireline segment while also enabling the construction of wireless packets therefrom. In certain embodiments, gaps may be generated between wireline packets to improve performance. This coordination between wireline transmission and wireless signal generation results in improved performance across a wireline-wireless connection within the architecture.

In certain embodiments, packets are generated from a plurality of streams that are intended for transmission across a wireline-wireless architecture. Each of these streams may be associated with a particular UE within a cell or remote device within a wireless LAN. These packets are multiplexed by the intermediate node (e.g., a CSL-IF unit) into a multi-stream signal prior to transmission on a wireline medium in accordance with a defined packetization and multiplexing process. The multi-stream-signal is received at a corresponding distribution node, demultiplexed, converted to wireless signals in accordance with a wireless standard and wirelessly transmitted to recipient devices. In certain embodiments, packets are multiplexed using interleaving techniques, as set forth below, in which multiple streams are combined into a single multi-stream signal. Interleaving techniques include, but are not limited to, interleaving packets on a one-by-one basis or interleaving blocks of packets into a single signal. Adjustments to interleaving process may be performed at initialization, intermittently during operation, responsive to bandwidth or interference changes within a wireline segment, or in real-time.

It is important to note that, in the context of various embodiments of the invention, the term “base station” includes both base station installations that incorporate a cell tower as well as base station installations that do not include a cell tower.

In this document, the disclosures are presented in the context of, but are not limited to applications that use, the cellular subscriber line (CSL) framework. Concepts related to the CSL framework are described in “Wireless-wireline physically converged architectures,” U.S. Patent Publication No. 2021/0099277 A1; and J. M. Cioffi et al., “Wireless-wireline physically converged architectures,” WIPO Patent Publication No. WO2021/062311, both of which are hereby incorporated by reference in their entireties. CSL systems use the existing wireline infrastructure (e.g., telephone lines, fiber-optic cables, Ethernet wires, coaxial cables, etc.) in conjunction with the wireless infrastructure to extend the coverage of wireless signals quickly, inexpensively, and securely. CSL systems can include hardware and/or software components to transmit and/or process signals at a variety of frequencies, including RF and IF. CSL systems are one example of wireline-wireless architectures.

Certain features and advantages of the present invention have been generally described in this summary section; however, additional features, advantages, and embodiments are presented herein or will be apparent to one of ordinary skill in the art in view of the drawings, specification, and claims hereof. Accordingly, it should be understood that the scope of the invention shall not be limited by the particular embodiments disclosed in this summary section.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates a wireline-wireless cloud-based architecture that includes intermediate and distribution nodes coupled to each other by a wireline cable (e.g., twisted pair, coaxial cable, etc.) in accordance with various embodiments of the invention.

FIG. 2 is an exemplary diagram of a cellular wireline-wireless architecture comprising at least one wireline segment and at least one wireless segment in accordance with various embodiments of the invention.

FIG. 3 illustrates an example of a packetization technique for use within a wireline segment according to various embodiments of the invention.

FIG. 4 illustrates another aspect of an example of a packetization within a wireline segment according to various embodiments of the invention.

FIG. 5 illustrates an exemplary intermediate node and communication flow according to various embodiments of the invention.

FIG. 6 illustrates different interleaving packet techniques used to generate multi-stream signals according to various embodiments of the invention.

FIG. 7 illustrates an exemplary downlink intermediate node architecture in which a single path is employed to generate a multi-stream downlink signal in accordance with various embodiments of the invention.

FIG. 8 illustrates an exemplary downlink intermediate node architecture in which multiple paths are employed to generate a multi-stream downlink signal in accordance with various embodiments of the invention.

FIG. 9 illustrates an exemplary uplink intermediate node architecture in which a single path is employed to demultiplex a multi-stream uplink signal in accordance with various embodiments of the invention.

FIG. 10 illustrates an exemplary uplink intermediate node architecture in which multiple paths are employed to demultiplex a multi-stream uplink signal in accordance with various embodiments of the invention.

FIG. 11 illustrates an exemplary distribution node and communication flow according to various embodiments of the invention.

### DETAILED DESCRIPTION OF THE PREFERRED EMBODIMENTS

Embodiments of the present invention provide systems, devices and methods for packetizing and multiplexing one or more streams from cellular equipment (e.g., BBU, base station, etc.) and/or Wi-Fi equipment for transmission on a wireline segment within a wireline-wireless architecture. In certain examples, streams are packetized in accordance with a preferred packetization process and combined into a multi-stream signal that is subsequently transmitted on a wireline segment. The multi-stream signal is received from the wireline segment, demultiplexed and processed to generate a plurality of wireless signals corresponding to the plurality of streams. The plurality of wireless signals is transmitted to intended recipients which may include user equipment within a cell, remote terminals within a Wi-Fi LAN, or any other type of device capable of receiving a wireless signal.

In certain examples, the architecture leverages pre-existing wireline connectivity within a building to allow a signal to traverse physical barriers, such as walls, on the wireline segment(s) while using wireless portions of the channel to communicate signals in air both outside and inside the building. The properties of the wireline segment(s) will affect the manner in which the signal propagates including bandwidth and attenuation constraints. Determination of how a multi-stream wireline signal is constructed may depend on a number of different variables including properties of the wireline and/or wireless segments. The multi-stream signal may be constructed using a variety of different interleaving techniques, including those described below, which are not intended to be limiting.

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of different electrical components, circuits, devices and systems. The embodiments of the present invention may function in various different types of environments wherein channel sensitivity and range are adversely affected by physical barriers within the signal path. Furthermore, connections between components within the figures are not intended to be limited to direct connections. Rather, connections between these components may be modified, re-formatted or otherwise changed by intermediary components.

Reference in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

The term “intermediate node” denotes a device that couples a BBU to a wireline segment and facilitates measurement of parameters on the wireline segment and transmits wireline signals to one or more radio nodes. The CSL-IF unit is one example of an intermediate node. The term “distribution node” denotes a device that couples a wireline segment to a wireless segment and that has a configurable MIMO antenna used to transmit and/or receive wireless signals from at least one device. The CSL-RF unit is one example of a distribution node.

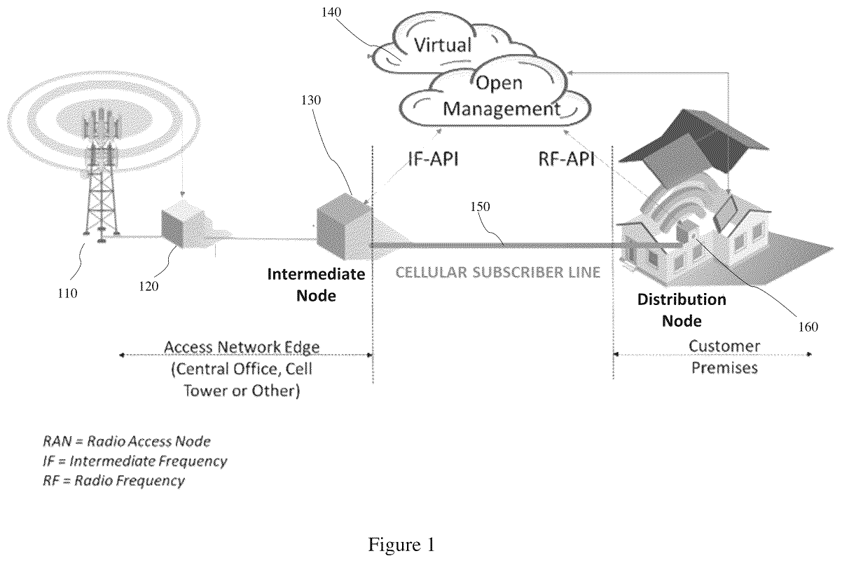

FIG. 1 illustrates a wireline-wireless cloud-based architecture that includes intermediate and distribution nodes coupled to each other by a wireline cable (e.g., twisted pair, coaxial cable, etc.) in accordance with various embodiments of the invention. The intermediate node 130 interfaces with a BBU 120 (which may include a base station 110) located, for example, at a cell-tower or at a central office of the cellular service provider (CSP). For purposes of this application the term “BBU” should be construed to cover a base station, central office, baseband unit or any other component operationally within a cell tower or cell tower system to transmit signals intended for user equipment and receive signals transmitted by the UE. The connection between the BBU 120 and the intermediate node 130 may be a wired connection according to various embodiments of the invention. In other embodiments, the connection between the BBU 120 and the intermediate node 130 may be wireless.

The intermediate node 130 receives one or more baseband digital streams from the BBU output (downlink direction) and converts the baseband digital streams to specific O-RAN split signals for the BBU input (uplink direction). As previously mentioned, these O-RAN signals may be communicated via a cable or wireless channel(s). In the downlink direction, the intermediate node 130 modulates the wireless baseband signal into intermediate frequency (IF) signal(s), and transmits the IF-modulated signal over the wireline cable 150 to a distribution node 160 at the other end of the wireline cable 150. The distribution node 160 up-converts the received signal to RF signals and transmits the RF signals to one or more UEs (e.g., IoT devices, smartphones, etc.). Similarly, in the uplink direction, the distribution node 160 receives RF signals from a UE, down-converts these signals to the IF, and transmits IF-modulated signals over the wireline cable 150 to the intermediate node 130.

The wireline cable 150 that couples the intermediate node 130 and distribution nodes 160 allows the intermediate node 130 to send IF-modulated baseband signals to the distribution node 160. The intermediate node 130 receives uplink samples from the distribution node 160, which had been down-converted by the distribution node 160 from the radio-frequency range to intermediate frequency. The wireline cable 150 has an impact on the performance of the wireline-wireless system and may require that multiple streams within the signal received from the BBU 120 to be combined into a single multi-stream signal for transmission on the wireline segment 150.

In certain embodiments, the wireline-wireless architecture may be managed or partially managed by a cloud-based system or server 140. For example, an IF-API and RF-API may provide connectivity to the cloud to enable remote management of system performance and integrity.

When using intermediate node 130 with MIMO over the wireless link, the intermediate node 130 may need to transmit downlink baseband inputs corresponding to multiple spatial streams to distribution node 160. Similarly, distribution node 160 may transmit signals corresponding to multiple spatial streams to the intermediate node 130. Thus, when using MIMO, more samples need to be sent over the wireline medium 150 over the same duration and thus this requires much higher wireline bandwidth. For transmitting multiple spatial streams, a single IF signal may be used or multiple intermediate frequency signals may also be used with one IF associated with a subset of spatial streams. As previously mentioned, one skilled in the art will recognize that a similar architecture may be employed to service multiple remote wireless devices in one or more Wi-Fi LANs.

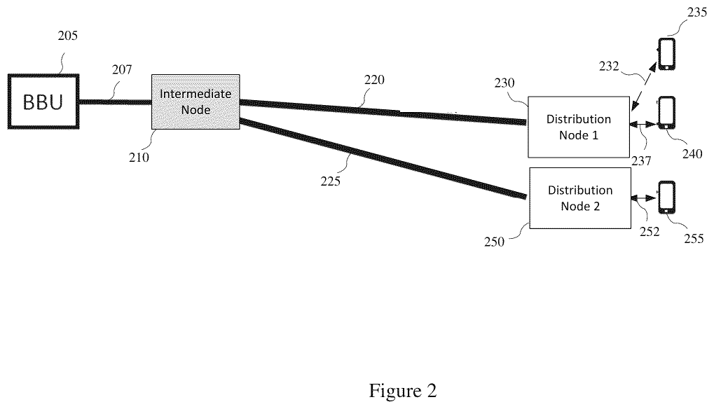

In some embodiments, a single intermediate node can be connected to a plurality of (i.e., two or more) distribution nodes in which some or all of the wireline segments transmit multi-stream signals as described below. FIG. 2 shows an example in which a single intermediate node 210 is coupled to a BBU 205 and coupled to two distribution nodes 230, 250. Specifically, the intermediate node 210 is coupled to distribution node 1 230 over a first wireline connection 220, and to distribution node 2 250 over a second wireline connection 225. In this example, a common baseband is transmitted between the BBU 205 and the intermediate node 210, but different signals are transmitted between the intermediate node 210 and the various distribution nodes 230, 250. In certain instances, the same signal may also be transmitted between an intermediate node and various distribution nodes coupled to it. The wireline connections between the intermediate node 210 and the various distribution nodes 230, 250 may multiplex streams across one or both of the wireline connections 220, 225.

In one instance, wireline connection 220 transmits a multi-stream signal in which a first stream intended for UE 235 and a second stream intended for UE 240 are multiplexed together. The first stream is wirelessly transmitted on channel 232 to UE 235 and a second stream is wirelessly transmitted on channel 237 to UE 240. In another instance, wireline connection 225 may transmit a single stream signal or multi-stream signal (e.g., multiple streams corresponding to different applications operating on the UE) to UE 255. This single or multiple streams is wirelessly transmitted on channel(s) 252 to UE 255.

One skilled in the art will recognize that the architecture and connectivity between the different devices are able to transmit both downlink and uplink. Time-division multiplexing or frequency division multiplexing may be deployed on each of the segments within the system.

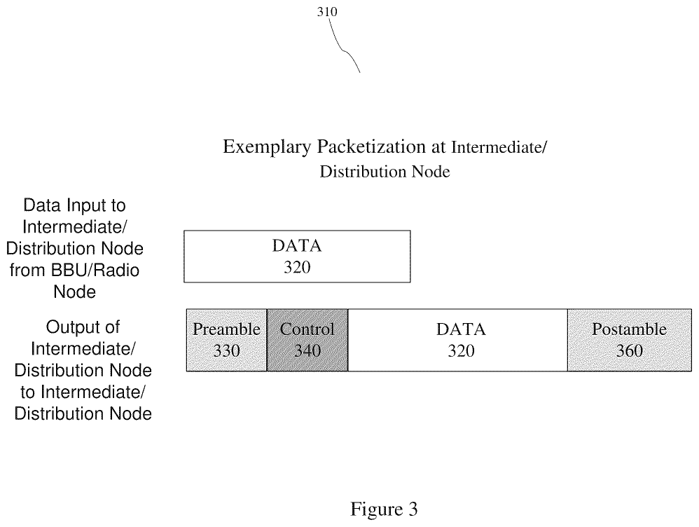

FIG. 3 illustrates an exemplary packetization structure 310 that may be employed in a wireline-wireless architecture according to various embodiments of the invention. One skilled in the art will recognize that other packetization structures may be employed that are consistent with and enabled by the description herein. As shown, data 320 is generated based on signals received from a BBU or other RF device such as Wi-Fi equipment. Packets generated by intermediate node (and sent to distribution node) comprise of wireline-wireless downlink data signal generated based on a subset of baseband downlink data received by intermediate node from BBU. If the data 320 is being transmitted on a downlink, an intermediate node packetizes the data 320 by generating control information 340 that is placed adjacent to the data 320 on its front end. In certain instances, modified data block may be obtained by modifying the data 320 using operations such as IFFT/FFT, upsampling/downsampling, filtering, up-conversion/down-conversion, etc. and may be used in place of data block 320 in a packet.

A preamble 330 is created and positioned adjacent to the control information and a postamble 360 is created and positioned adjacent to data 320 as shown in the illustration. The control information, preamble and postamble are used by a distribution node to process the packet and generate a wireless signal to be transmitted to a user equipment. In some embodiments, a) only a subset of preamble, control information and postamble is used (for example, it may be sufficient to add only a preamble in certain settings) b) a preamble, a control information and postamble could be associated with one or more data received from a BBU (for instance, we may only send one control information or one preamble for all symbols of a slot). The sequence of the control and data may be reversed in accordance with various embodiments of the invention.

If the data 320 is being transmitted on the uplink, then packetization occurs on a distribution node and transmitted to an intermediate node. The intermediate node processes the packet and generates a signal to be transmitted to a BBU. In certain embodiments, packets generated by the distribution node (and sent to the intermediate node) are based on a subset of uplink data received by the distribution node in which: (1) the subset may be a subset of resource blocks, (2) it may be determined based on wireline-wireless control information sent by the intermediate node to the distribution node, (3) which in turn may be determined using ORAN control signals received by the intermediate node.

In various embodiments, data 320 comprises one or more time-domain IFFT signals that include both wireless data and control. The control information 340 may include information related to distribution node ON/OFF status, statistics of the intermediate node, and TDD frame format (e.g., DDDUUDDDUU) of a wireless segment to name a few. One skilled in the art will recognize that other information may be included in the control information.

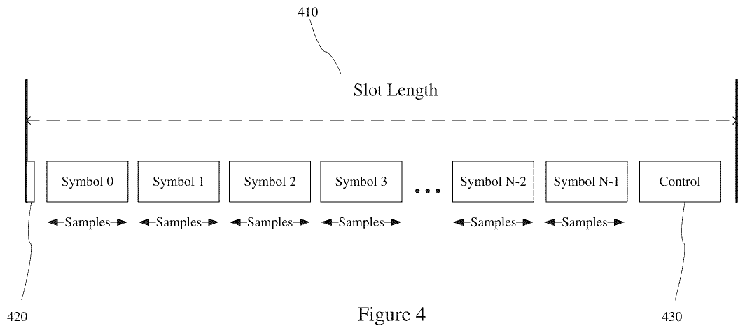

FIG. 4 illustrates a detailed packetization structure of a downlink packet according to various embodiments of the invention. As shown, a packet is shown within a predefined slot length 410 and may be used within a 5G deployment of the wireline-wireless architecture. A first set of symbols 420 represents the preamble and a second set of symbols 430 represents control information. The transmissions associated with N (indexed 0 to 13) symbols in a slot are separated by gaps (durations without any transmission). If this packetization structure is deployed in a 5G architecture with 4096 IFFT output samples per symbol and intermediate node performs 4× upsampling, then (1) N is equal to 14, (2) the first symbol (symbol 0) contains 17792 samples, (3) subsequent symbols (symbols 1-13) contain 17536 samples, and (4) the gaps between each of the symbols contains 500 samples. One skilled in the art will recognize that aspects of the packetization structure may be modified to support other configurations of 5G (e.g., other subcarrier choices, number of streams, lower bandwidth, etc.) and various standards including Wi-Fi standards.

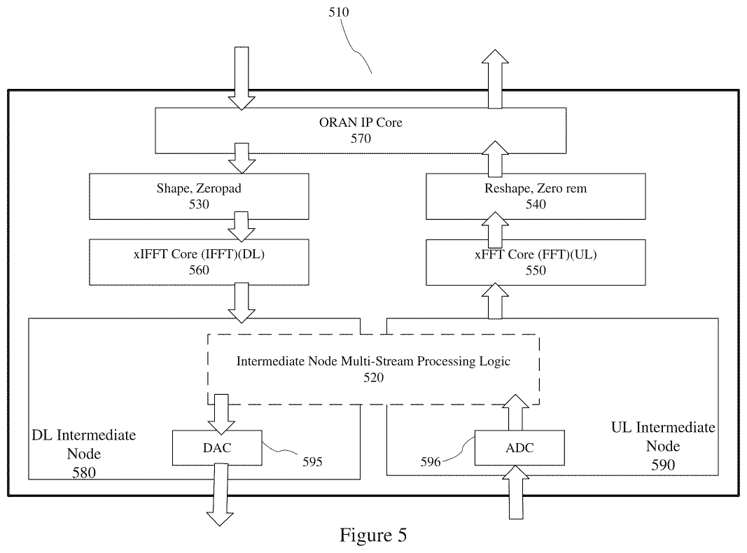

FIG. 5 illustrates an exemplary intermediate node showing uplink and downlink paths according to various embodiments of the invention. The intermediate node 510 comprises an ORAN IP core 570 that interfaces with and provide interoperation with cellular equipment such as BBUs. Various embodiments of the ORAN IP core 570 provides frequency domain operations on wireless baseband signals such as adding/removing guard subcarriers (at the edge of signals spectrum) and zero/low strength DC subcarriers (at very low frequencies). The ORAN IP core 570 may also process O-DU packets including the step of obtaining O-RAN control, synchronization and data information. Other functions may also be performed by the ORAN IP core 570 as understood by one of skill in the art.

Both the uplink and downlink paths also comprise multi-stream processing logic 520 that provides functionality to multiplex downlink streams into multi-stream signals and de-packetization of uplink multi-stream signals. As previously stated, interleaving multiple streams within a wireline signal allows the architecture to coordinate performance (such as bandwidth management) between wireline segments and wireless segments. The operation of this multi-stream processing logic 520 is described in more detail later in the application.

Referring to the downlink path, cellular (or other wireless types of signals such as Wi-Fi) signals are received at ORAN IP core 570. The ORAN processed signal is provided to a Shape and Zeropad logic 530 that performs (a) shaping (e.g., re-ordering of input samples) of spatial streams, and (b) addition of guard samples, zeros and DC subcarriers. The shaping of spatial streams is performed on samples received from the ORAN IP core 570 where a certain number of samples (which may correspond to a 5G sample/symbol/slot or a part thereof) for each stream are involved. In some embodiments, the shaping of spatial streams is used to convert the output of ORAN IP core 570 into a format suitable for xIFFT core 560. For instance, ORAN IP core 570 output may use a single output port for multiple streams whereas xIFFT core 560 may have one separate input port for each stream. This process may be realized in a variety of different ways including embodiments where multiple streams are shaped.

The shaped streams are provided to an xIFFT core 560 that performs functions that convert the streams from the frequency domain to time domain. Thereafter, each stream is transmitted to multi-stream processing logic 520 for processing in preparation to transmission on a wireline segment within the architecture. The multi-stream processing logic 520 is located within a downlink intermediate node path 580 and provides upsampling/interpolation, filtering and up-conversion to an intermediate frequency for transmission on the wireline, which may include setting center frequencies of the up-conversion based at least partially on frequencies used by other transmissions on the wireline medium and/or number of spatial streams. Thereafter, the signals are filtered and transmitted to a digital-to-analog converter 595.

Referring to the uplink path, wireline signals are received at an intermediate node uplink path 590 and converted to a digital signal by an analog-to-digital converter 596. The converted digital signal is received at the multi-stream processing logic where it is demultiplexed and processed to a plurality of streams, and this may involve operations such as down-conversion and filtering. This demultiplexing and related functions are described in more detail below. The demultiplexed streams are transmitted to an xFFT core 550 that converts the streams from the time domain to the frequency domain. In some embodiments, intermediate node uplink path 590 may perform additional functions such as PRACH filtering/extraction, SRS filtering/extraction etc.

The converted streams are transmitted to a reshape and zero removal logic 540 that reshapes the converted streams and removes any zeros that were added by the Zeropad operation. The reshape and zero rem logic 540 performs (a) reshaping (e.g., reordering) of spatial streams and control, and (b) operation involving removal of guard and DC subcarriers. In some embodiments, the reshaping is used to convert the output of xFFT core 550 into a format suitable for ORAN IP core 570.

The demultiplexed and processed streams are transmitted to the ORAN IP core 570 that further processes the streams to provide interoperability with the BBU at a base station.

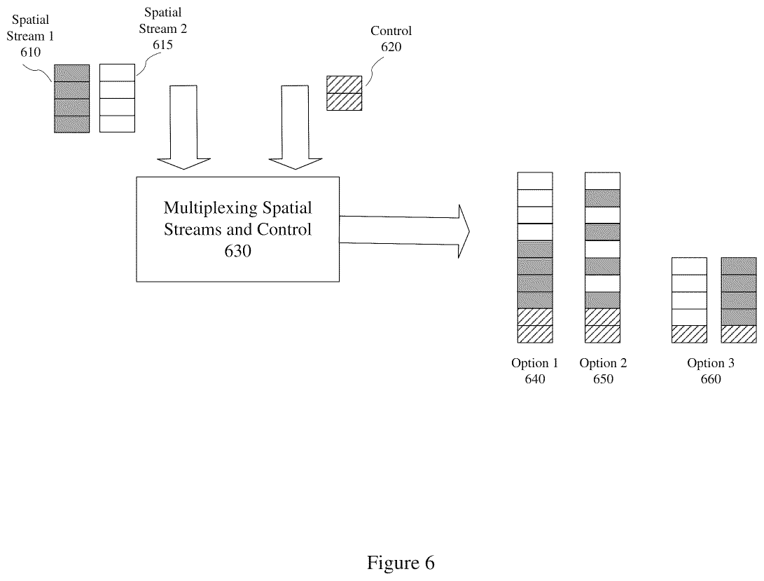

FIG. 6 illustrates three examples of multiplexing functions operable within the multi-stream processing logic 520 in accordance with various embodiments of the invention. As shown, the multiplexing spatial streams and control logic 630 receives a first spatial stream 610, a second spatial stream 615 and control information 620 in this particular example of one or more embodiments. The multiplexing spatial streams and control logic 630 may interleave these inputs using a variety of methods including the three examples described herein.

In a first example, blocks of the first spatial stream 610 and blocks of the second stream 615 are interleaved. In this illustration, the block length is four blocks in length but the block length may vary across different embodiments. Control information 620 is positioned in front of the interleaved spatial stream blocks as shown in option 1 640. In a second example, the first spatial stream 610 and second spatial stream 615 are interleaved on a block-by-block basis (block length is one) with control information 620 positioned in front of the interleaved streams.

In a third example, the multiplexing spatial streams and control logic 630 creates two streams in which each of the spatial streams 610, 615 with corresponding control information 620. The resulting multiplexed signals results in two discrete multiplexed signals in which control information is positioned in front of each of the first spatial stream 610 and second spatial stream 615. One skilled in the art will recognize that variations of these three options may also be within the scope of embodiments of the invention including where all control is positioned along with one stream. This can be useful if that stream has more favorable transmission conditions (e.g., lower attenuation due to it occupying lower part of the wireline segment's spectrum) over the wireline segment.

One skilled in the art will recognize that a variety of different interleaving/multiplexing processes may be employed in different embodiments of the invention, all of which should fall within the scope of the invention.

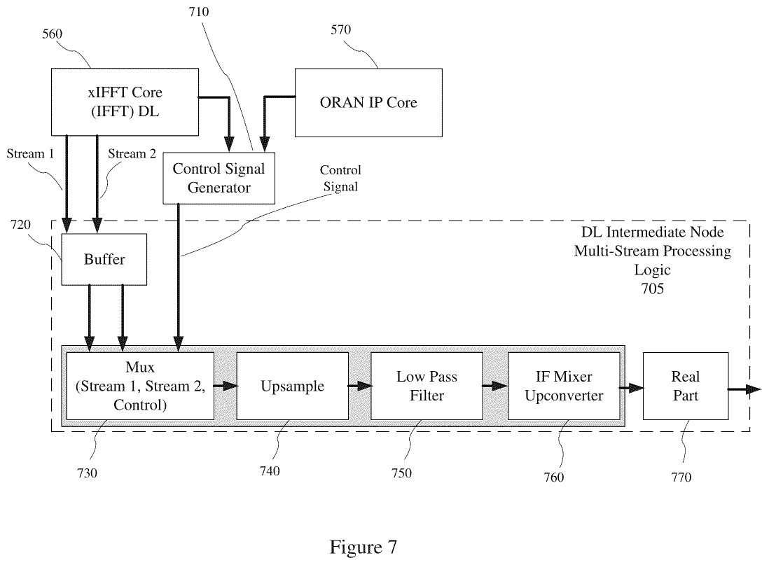

FIG. 7 illustrates exemplary downlink intermediate node multi-stream processing logic 705 in accordance with various embodiments of the invention. In this particular example, the downlink intermediate node multi-stream processing logic comprises a buffer 720 and a single multiplexing path that combines a plurality of spatial streams and control information into a single multi-stream signal.

As shown, the buffer 720 receives a plurality of streams (in this example there are two streams) from the xIFFT core 560 and temporarily stores the streams. A control signal generator 710 receives control information from the xIFFT core 560 and the ORAN IP core 570, and generates a control signal that will be multiplexed with the plurality of streams.

A multiplexer 730 receives the plurality of streams from the buffer 720 and the control signal from the control signal generator 710. The multiplexer 730 combines the plurality of streams and control signal to generate a multi-stream signal. Examples of how the streams and control signals are multiplexed are shown as option 1 640 and option 2 650. However, one skilled in the art will recognize that other multiplexing processes may be used within embodiments of the invention.

The multi-stream signal is transmitted to upsample logic 740, which upsamples the multi-stream signal at a higher rate. The resulting signal is provided to a low-pass filter 750, an IF mixer up-converter 760, and real-part extractor 770 which generates a signal used for transmission on a wireline after a DAC operation such as the DAC 595. The up-converted signal operates at an intermediate frequency that may be communicated on the wireline medium.

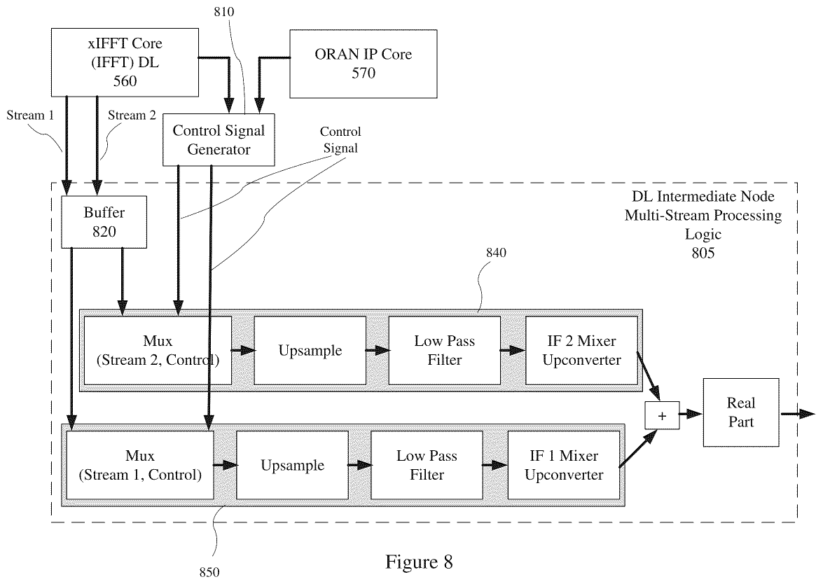

FIG. 8 illustrates another embodiment of the downlink intermediate node multi-stream processing logic in accordance with various embodiments. Comparative to the previous example, the downlink intermediate node multi-stream processing logic 805 comprises a buffer 820 and multiple multiplexing paths that combine a plurality of spatial streams and control information into one or more signals. One example of how a plurality of signals is generated is described as option 3 660.

The buffer 820 receives a plurality of streams (in this example there are two streams) from the xIFFT core 560 and temporarily stores the streams. A control signal generator 810 receives control information from the xIFFT core 560 and the ORAN IP core 570, and generates control signals that will be multiplexed with the plurality of streams.

The buffer 820 provides a first stream to a first multiplexing path 850. The control signal generator 810 provides a first control signal to the first multiplexing path 850. The first multiplexing path 850 operates in a similar manner as discussed in FIG. 7 with the first multiplexing path 850 combining the first stream with at least a part of the control information. The resulting signal is a combination of the first stream and a first control signal.

The buffer 820 provides a second stream to a second multiplexing path 840. The control signal generator 810 provides a second control signal to the second multiplexing path 840. The second multiplexing path 840 operates in a similar manner as discussed in FIG. 7 with the second multiplexing path 840 combining the second stream with control information. The resulting signal is a combination of the second stream and a second control signal.

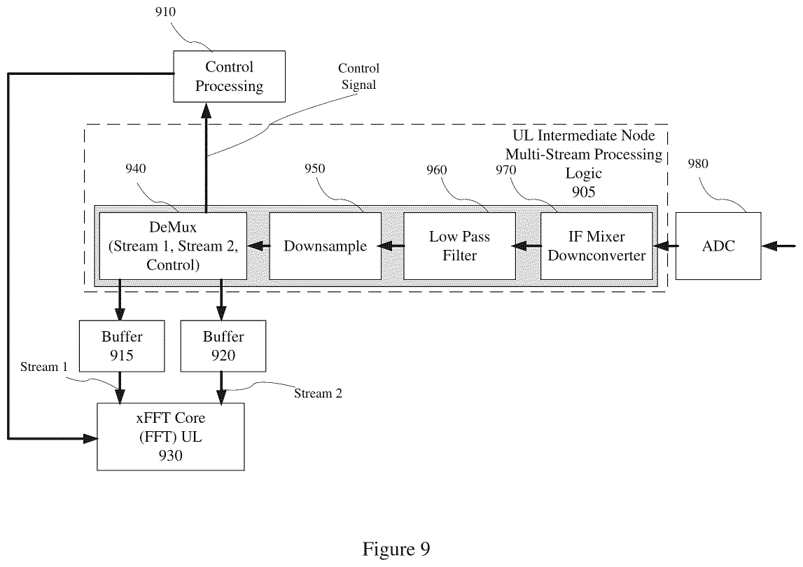

FIG. 9 illustrates exemplary uplink intermediate node multi-stream processing logic according to various embodiments of the invention. The uplink intermediate node multi-stream processing logic 905 comprises a demultiplexer 940, downsample logic 950, a low-pass filter 960 and an IF mixer down-converter 970.

As shown, an uplink multi-stream signal is converted to a digital signal by an analog-to-digital converter 980. Examples of the multi-stream signal may be those corresponding to option 1 640 and option 2 650 in FIG. 6 in which a plurality of streams and control information are interleaved into a single signal.

The converted digital signal is received by the uplink intermediate node multi-stream processing logic 905 at an IF mixer down-converter 970, which down-converts the digital signal. The down-converted signal is filtered by low-pass filter 960 and down sampled by downsample logic 950. The downsampled signal is provided to a demultiplexer 940 which generates a plurality of streams (in this instance two streams) and a control signal.

In this example, the plurality of streams comprises a first stream and a second stream which are provided to corresponding buffers 915, 920. The demultiplexer 940 also extracts the control signal from the multi-stream signal and provides the control signal to control processing logic 910. One skilled in the art will recognize that various number of streams may be combined within a multi-stream signal and extracted by the demultiplexer 940.

The buffers 915, 920 transmit the first and second streams to an xFFT core 930 and the control processing logic 910 transmits control information to the xFFT core 930. The xFFT core 930 converts the first and second streams (and may also convert at least a portion of the control information) to the frequency domain to the time domain, from which a corresponding signal is eventually transmitted to a BBU.

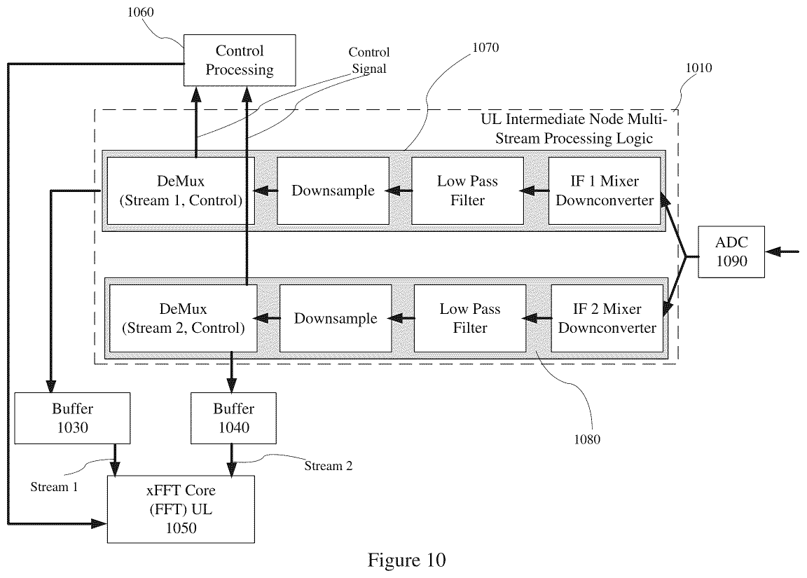

FIG. 10 illustrates another example of an uplink intermediate node multi-stream processing logic according to various embodiments of the invention. As shown, the uplink intermediate node multi-stream processing logic 1010 comprises a plurality of demultiplexing paths (in this case two paths) 1070, 1080. This uplink intermediate node multi-stream processing logic 1010 may demultiplex streams similar to those illustrated in option 3 660 in FIG. 6.

A multi-stream signal is received at an ADC 1090 that converts the signal from the analog domain to the digital domain. Examples of multi-stream signals include those in which control information and a data stream are combined such as those in option 3 660. The signal generated by the ADC is provided to demultiplexing paths 1070, 1080 for demultiplexing data and control.

In this embodiment, a signal is down-converted, filtered by a low-pass filter and downsampled prior to being transmitted to a demultiplexer. The demultiplexer separates data and control. In this example, a first demultiplexer sends a first stream to a first buffer 1030 and a first control signal to control processing logic 1060. A second demultiplexer sends a second stream to a second buffer 1040 and a second control signal to control processing logic 1060.

The control processing logic 1060 sends part of the control information to the xFFT core 1050. The first buffer 1030 sends the first stream to the xFFT core 1050 and the second buffer 1040 sends the second stream to the xFFT core 1050. The xFFT core 1050 converts the first and second streams (and may convert at least a portion of the control information) from the time domain to the frequency domain. The converted first and second streams (and also the at least portion of the control information if applicable) is sent to an ORAN core which generates corresponding signals that are transmitted to the BBU.

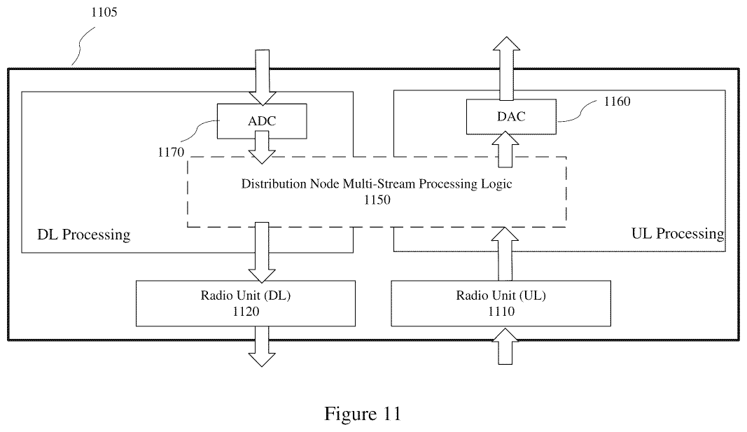

FIG. 11 illustrates an exemplary distribution node according to various embodiments of the invention. The distribution node 1105 interfaces the wireline segment and a wireless segment and comprises a downlink path and an uplink path.

The uplink path comprises an uplink Radio unit 1110 that interfaces the distribution node 1105 with wireless segments within a cell or wireless LAN. Wireless signals are received at the Radio unit 1110 and processed to allow multiplexing of multiple streams within the distribution node 1105. Uplink distribution node multi-stream processing logic 1150 receives a plurality of streams from the Radio unit 1110 and generates a multi-stream signal in a similar manner as described in the downlink intermediate node multi-stream processing logic 705, 805. The resulting multi-stream signal is transmitted to a digital-to-analog converter 1160 and subsequently transmitted on a wireline.

In the downlink, analog-to-digital converter 1170 receives a multi-stream signal from a wireline and converts it to a digital signal. The digital signal is transmitted to downlink distribution node multi-stream processing logic 1150 and demultiplexes the signal into a plurality of streams in a similar manner as described in the uplink intermediate node multi-stream processing logic 905, 1010. The streams are transmitted to a downlink Radio unit 1120 that converts the streams to wireless signals and transmits them wirelessly to intended user equipment and/or remote devices.

It is to be understood that although the disclosures herein are largely in the context of a wireline-wireless converged architecture, the disclosures are not limited to the described environments or applications. Furthermore, although certain 3GPP/cellular terminology and acronyms or initialisms are used herein (e.g., RB, BBU, RAN, MCS, UE, etc.), those having ordinary skill in the art will understand that other terms may be used in other contexts (e.g., Wi-Fi, IEEE 802.11 standards, etc.). For example, in multi-carrier systems (such as those that use orthogonal frequency division multiplexing or discrete multitone modulation), a resource block (which may also be referred to as a resource element) is simply a quantity of time and frequency that can be assigned to a device. It is to be appreciated that resources allocated for communication over a channel can be described in other ways.

In the foregoing description and in the accompanying drawings, specific terminology has been set forth to provide a thorough understanding of the disclosed embodiments. In some instances, the terminology or drawings may imply specific details that are not required to practice the invention.

To avoid obscuring the present disclosure unnecessarily, well-known components are shown in block diagram form and/or are not discussed in detail or, in some cases, at all.

Unless otherwise specifically defined herein, all terms are to be given their broadest possible interpretation, including meanings implied from the specification and drawings and meanings understood by those skilled in the art and/or as defined in dictionaries, treatises, etc. As set forth explicitly herein, some terms may not comport with their ordinary or customary meanings.

As used herein, the singular forms “a,” “an” and “the” do not exclude plural referents unless otherwise specified. The word “or” is to be interpreted as inclusive unless otherwise specified. Thus, the phrase “A or B” is to be interpreted as meaning all of the following: “both A and B,” “A but not B,” and “B but not A.” Any use of “and/or” herein does not mean that the word “or” alone connotes exclusivity.

The terms “exemplary” and “embodiment” are used to express examples, not preferences or requirements. The term “coupled” is used herein to express a direct connection/attachment as well as a connection/attachment through one or more intervening elements or structures.

Although specific embodiments have been disclosed, it will be evident that various modifications and changes may be made thereto without departing from the broader spirit and scope of the disclosure. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

The foregoing description of the invention has been described for purposes of clarity and understanding. It is not intended to limit the invention to the precise form disclosed. Various modifications may be possible within the scope and equivalence of the appended claims.

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. Although the figures and the discussion thereof provide an exemplary computing system and methods, these are presented merely to provide a useful reference in discussing various aspects of the invention. Embodiments of the invention may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules; multiple method steps implemented in flowcharts contained herein, or as described above, may be implemented together by a single module.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

What is claimed is:

1. An intermediate node comprising:
a first interface coupled to a BBU, the first interface receives a cellular signal;
a xIFFT core coupled to receive the at least one cellular stream corresponding to the cellular signal, the xIFFT converts the at least one cellular stream to a set of at least one stream in a time domain;
downlink intermediate node multi-stream processing logic coupled to the xIFFT core, the downlink intermediate node multi-stream processing logic multiplexes the at least one stream in the time domain into at least one multi-stream signal; and
a digital-to-analog converter coupled to receive the at least one multi-stream signal, the digital-to-analog converter converts the at least one multi-stream signal into an at least one analog multi-stream signal that is transmitted on a wireline segment within a wireline-wireless architecture.

2. The intermediate node of claim 1 further comprising an ORAN IP core coupled to the xIFFT core, the ORAN IP core provides interoperability between the intermediate node and the BBU.

3. The intermediate node of claim 2 further comprising a control signal generator coupled to the ORAN IP core and the xIFFT core, the control signal generator receives at least one of a first control information from the xIFFT core and a second control information from the ORAN IP core, the control signal generator generates a control signal based at least partially on the at least one of the first and second control information.

4. The intermediate node of claim 3 comprising at least one buffer coupled to the xIFFT core, the at least one buffer receives and stores the set of at least one stream in the time domain received from the xIFFT core.

5. The intermediate node of claim 4 wherein the downlink intermediate node multi-streaming processing logic comprises a multiplexer coupled to receive the set of at least one stream in the time domain and the control signal, the multiplexer generates a multi-stream signal comprising the set of at least one stream in the time domain and at least a portion of the control signal.

6. The intermediate node of claim 5 wherein the downlink intermediate node multi-stream processing logic further comprises one or more of upsample logic, a low-pass filter, an IF mixer up-converter, and a real-part extractor.

7. The intermediate node of claim 1 wherein the downlink intermediate node multi-stream processing logic comprises a single multiplexing path.

8. The intermediate node of claim 7 wherein the single multiplexing path interleaves the set of at least one stream in the time domain and the at least a portion of the control signal on a data block-by-data block basis.

9. The intermediate node of claim 7 wherein the single multiplexing path interleaves the set of at least one stream in the time domain and the at least a portion of the control signal on a multi-data-block-by-multi-data-block bases, the multi-block having a block length greater than one.

10. The intermediate node of claim 1 wherein the downlink intermediate node multi-stream processing comprises a plurality of multiplexing paths.

11. The intermediate node of claim 10 wherein each of the plurality of multiplexing paths interleaves the set of at least one stream in the time domain with the at least a portion of the control signal.

12. A intermediate node comprising:
a first interface coupled to a wireline segment, the first interface receives a multi-stream signal from the wireline segment;
an analog-to-digital converter coupled to receive the multi-stream signal, the analog-to-digital converter converts to multi-stream signal to a first digital multi-stream signal;
an uplink intermediate node multi-stream processing logic coupled to the analog-to-digital converter, the uplink intermediate node multi-stream processing logic demultiplexes the digital multi-stream signal to at least one of one stream and control information within the time domain; and
a xFFT core coupled to receive the at least one of one stream and the control information within the time domain, the xFFT converts the at least one of one stream and control information within the time domain and to at least one of one stream and control information within the frequency domain for subsequent transmission to a BBU.

13. The intermediate node of claim 12 further comprising an ORAN IP core coupled to the xFFT core, the ORAN IP core provides interoperability between the intermediate node and the BBU.

14. The intermediate node of claim 12 further comprising at least one buffer and control processing logic coupled to the uplink intermediate node multi-stream processing logic.

15. The intermediate node of claim 14 wherein the uplink intermediate node multi-stream processing logic comprises a single demultiplexing path.

16. The intermediate node of claim 15 wherein the uplink intermediate node multi-stream processing logic comprising a demultiplexer coupled to receive the digital multi-stream signal, the demultiplexer generates at least one of a first stream, a second stream and control information from the digital multi-stream signal.

17. The intermediate node of claim 16 wherein the plurality of buffers receives and stores the at least one of the first and second streams.

18. The intermediate node of claim 17 wherein the xFFT core is coupled to receive the at least one of the first and second streams, the xFFT core converts the at least one of the first and second streams to the frequency domain.

19. The intermediate node of claim 14 wherein the uplink intermediate node multi-stream processing logic comprises a plurality of demultiplexing paths.

20. The intermediate node of claim 19 wherein the plurality of demultiplexing paths receives the digital multi-stream signal from the analog-to-digital converter, each of the plurality of demultiplexing paths generates at least one stream from the digital multi-stream signal.

21. The intermediate node of claim 20 wherein the at least one stream comprises control information.

22. The intermediate node of claim 12 wherein the multi-stream signal comprises at least one of one stream and control information.

23. The intermediate node of claim 12 wherein the control processing logic receives the control information and generates a control signal.
